(19) United States
(12) Patent Application Publication
(10) Pub. No.: US 2015/0343624 A1
(43) Pub. Date: Dec. 3, 2015

(54) Dutchman Fastener Removal Tool

(71) Applicant: ToolTech, LLC, Phoenix, AZ (US)

(72) Inventor: Jake Merrick, Hinton, OK (US)

(21) Appl. No.: 14/824,173

(22) Filed: Aug. 12, 2015

Related U.S. Application Data
(63) Continuation of application No. 13/767,758, filed on Feb. 14, 2013, now abandoned.

(51) Int. Cl. B25B 27/18; B25B 23/00; B25B 13/18; B25B 13/50

(52) U.S. Cl. CPC B25B 27/18; B25B 13/5083; B25B 23/0035; B25B 13/18

(57) ABSTRACT

A tool for removing a listener having a cylindrical aperture includes a base, a camshaft, a sleeve and a cartridge. The camshaft includes lobes that extend from a camshaft top surface to a top surface of the base. The cartridge includes a cartridge top surface, a cartridge lip and a plurality of jaws. Each jaw includes a jaw counterclockwise outer frictional surface and a jaw counterclockwise inner cam surface. The cartridge is fixedly coupled to the sleeve and the cartridge interfaces with the camshaft. Additionally, the jaw inner cam surface interfaces with the camshaft cam profiles. The jaws rotate and engage the walls of the fastener cylindrical aperture.

### CROSS-REFERENCE

The present patent application is a continuation of Ser. No. 13/767,758 filed Feb. 14, 2013.

### FIELD

The invention is related to a fastener removal tool. More particularly, this invention relates to a tool for the removal of broken or rusted threaded members such as studs, screws or bolts.

### BACKGROUND

Studs, screws and bolts are a type of fastener with a threaded cylindrical barrel on one end of the fastener that mates with a complementary thread in a fixture. On a bolt or screw, one end of the fastener includes a head, which may be hexagonal shaped. Alternatively, the fastener may have a slotted or recessed head for insertion of a tool used for rotational removal. However, heads of such listeners are prone to breakage when excessive torque is applied.

Bolts and screws are traditionally removed using hand wrenches or screwdrivers by applying a counterclockwise rotational force to the head of the fastener. However, where the head of the fastener has been damaged or broken off through the application of excessive torque, or where the fastener has been corroded, it is very difficult and time consigning to remove such bolts and screws.

Studs and threaded rods that do not have heads are commonly removed by tightening two nuts together on the accessible threaded side of stud, and then applying a counterclockwise rotational force to one of the nuts. This technique for stud removal is much more difficult for a stud that has been corroded or has been in the same place for some time. Studs that have been corroded or have been in place for some time are prone to breaking, and so there is a need for a removal tool for broken studs.

A further complication of screw and stud removal using manual tools is that, where the screw or stud is very large, such as those used in oil production, manual removal using a wrench of such damaged screws and studs presents danger to the operator, or removal is impossible because of the degree of torque required for removal.

Another complication of stud and screw removal with conventional tools which grip the head of the fastener is that such tools do not work when the head of a stud or a screw is so damaged, or has broken off that it cannot be gripped by the tool. Some tools resolve this issue by gripping the exposed threaded surface of the broken fastener. However, this type of tool does not work when the broken fastener does not have sufficient exposed surface area for gripping.

One type of device accomplishes fastener removal by inserting an electrode into the broken stud and using a series of intermittent electrical arcs to disintegrate the stud, leaving a stud casing which is then removed manually. Finally, the threads of the fixture are cleaned. However, this method of removal results in damage to the stud, is time consuming, involves multiple steps for stud removal, and may result in damage to the fixture.

Devices for the removal of fasteners having broken rods or heads using an air impact tool exist; however, many of these devices are prone to breakage. Another complication of fastener removal using a hand-powered tool is side loading, or the mechanical binding of threaded surfaces against each other. When side loading occurs, heat builds up due to friction between the threaded surfaces, and creates a gall which is carried through the housing, tearing out the threads, and actually impeding removal.

Yet another complication is “chattering,” where the tool does not perfectly conform to the size of the fastener. When rotative force is applied using an air impact tool, the removing tool “chatters” over the damaged corners of the fastener, further stripping the fastener or damaging the tool interface with the fastener, and causing ‘radii’ to form on the end of the tool.

Another tool for removing a fastener with a broken rod or head is a drill bit. The operator drills into the fastener, such that the fastener attaches to the drill bit. The operator then reverses the direction of the drill bit to rotate the fastener out of the fixture. However, this method frequently results in the drill bit breaking while attached to the fastener, so that both the fastener and the drill bit are stuck within the fixture.

A further problem is presented when using a single device for fastener removal, because the device is limited to the size of fastener which it can remove; that is, different sized fasteners cannot be removed with the same tool because the fastener heads cannot fit within the tool, or because the entire tool is so rigid that the tool is prone to breakage when torque is applied.

The use of a set of tools having a multiplicity of sizes to conform to different screw head sizes could solve problem of imperfect conformance between removal tool and fastener size. However, regardless of the size, the result is chattering from an imperfect size conformance; thus stripping of the fastener socket occurs.

Further, the use of a set of tools having a multiplicity of sizes to conform to socket sizes presents another complication. If there exists a multiplicity of removal tool sizes in a set, the loss of one of the tools results in a useless tool set.

While the use of an air impact tool may eliminate much of the operator danger associated with hand wrenches, the use of an air impact tool presents a further problem. That is, the air impact tool, itself, creates a shock upon impact with the screw. When using sockets attached to air impact tools for screw removal, this shock impact can damage both the screw and adjacent surfaces. A further complication of some devices is that ridged teeth on the gripping surface of the jaws strip the screw socket.

It would thus be desirable to have a fastener removal tool that can remove broken or rusted threaded members such as studs, screws or bolts.

### SUMMARY

An apparatus for removing a fastener having a cylindrical aperture is described. The apparatus includes a base, a camshaft, a sleeve, and a cartridge. The base includes a base top section and a base bottom section. The base top section has a base top surface and a base groove. The base bottom section has an opening at a base bottom surface for interfacing with a rotary tool. The camshaft includes a camshaft top surface, a camshaft bottom surface, and at least one lobe that each extends from the camshaft top surface to the base top surface. The camshaft rotates with the base.

The sleeve includes a sleeve lip, a sleeve bottom surface and a sleeve interior sidewall disposed between the sleeve lip and the sleeve bottom surface. The sleeve interior sidewall includes a sleeve groove. The cartridge includes a cartridge top surface, a cartridge lip and a plurality of jaws. Each jaw includes a jaw counterclockwise outer frictional surface and a jaw counterclockwise inner cam surface. The cartridge is configured to be fixedly coupled to the sleeve.

The cartridge interfaces with the camshaft. Additionally, the jaw inner cam surface interfaces with at least one camshaft cam profile. The jaws rotate and engage an opening in the fastener.

In the illustrative embodiment, each lobe is substantially semi-circular and occupies a 120° arc. Additionally, by way of example and not of limitation, an elastic component is configured to join the plurality of jaws and the sleeve.

In operation, the jaw counterclockwise inner cam surface is configured to engage with a camshaft counterclockwise cam surface when a counterclockwise force is applied to the camshaft using an impact rotary tool. The base bottom section interfaces with an impact rotary tool that can apply a counterclockwise force. Additionally, the base further comprises a slot configured to receive a pin that is inserted within the slot when the base opening interfaces with the impact rotary tool.

In the illustrative embodiment, a combined cartridge is presented that includes the cartridge being fixedly coupled to the sleeve. Additionally, the illustrative embodiment includes a canted coil spring that is received by the sleeve groove and the base groove. The canted coil spring enables the combined cartridge to interface with the camshaft. The canted coil spring operates within a constant deflection range when an axial load is applied. Furthermore, a plurality of different sized combined cartridges may be used, in which each combined cartridge is sized for a fastener having a particular diameter.

### BRIEF DESCRIPTION OF THE DRAWINGS

FIG. 1A shows an exploded isometric view of the illustrative dutchman fastener removal tool.

FIG. 1B shows an exploded view of a canted coil spring.

FIG. 2A shows a canted coil spring wound in a clockwise direction about the coil centerline.

FIG. 2B shows a canted coil spring wound in a counterclockwise direction about the coil centerline.

FIG. 2C shows a canted coil spring with deflection and a graph of force and deflection.

FIG. 2D shows an illustrative knitted spring tube.

FIG. 3A shows a top view of the camshaft disposed within the camshaft base of the illustrative dutchman fastener removal tool wherein the camshaft is not disposed within the cartridge.

FIG. 3B shows a bottom view of the illustrative dutchman fastener removal tool.

FIG. 4A shows a partial cross-sectional view of the camshaft disposed within the camshaft base of the dutchman fastener removal tool, without the cartridge or canted coil spring.

FIG. 4B shows a top view of an illustrative camshaft.

FIG. 5A shows a top view of an illustrative camshaft disposed within the cartridge.

FIG. 5B shows a partial cross-sectional view of an illustrative cartridge without the canted coil spring.

FIG. 6 shows a side view of the illustrative camshaft disposed within the cartridge, both positioned within an illustrative broken stud.

### DESCRIPTION

Persons of ordinary skill in the art will realize that the following description is illustrative and not in my way limiting. Other embodiments of the claimed subject matter will readily suggest themselves to such skilled persons having the benefit of this disclosure. It shall be appreciated by those of ordinary skill in the art that the apparatus and systems described herein may vary as to configuration and as to details. Additionally, the methods may vary as to details, order of the actions or other variations without departing from the illustrative method disclosed herein.

It is to be understood that the detailed description of illustrative embodiments provided for illustrative purposes. The scope of the claims is not limited to these specific embodiments or examples. Various structural limitations, elements, details, and uses can differ from those described, or be expanded on or implemented using technologies not yet commercially viable, and yet still be within the inventive concepts of the present disclosure. The scope of the invention is determined by the following claims and their legal equivalents.

The apparatus described herein is a tool for the removal of broken or rusted threaded members such as studs, screws or bolts. When an illustrative stud or bolt is broken, a “dutchman” or cylindrical aperture is drilled into the center of the illustrative broken stud. For purposes of this patent, the terms dutchman, cylindrical aperture, and drilled hole are used interchangeably. The walls of the cylindrical aperture interface with a “combined cartridge” of the fastener removal tool described herein. The dutchman fastener removal tool includes a camshaft that interfaces with the combined cartridge. The camshaft interfaces with a base that is operatively coupled to an impact wrench. The combined cartridge also interfaces with the base. In operation, the dutchman fastener removal tool is inserted into the bored or drilled cylindrical aperture, and an impact wrench interfaces with tool, which enables an operator to remove a broken stud, screw or bolt.

Generally, the apparatus described herein is applied to broken fasteners such as bolts, studs and screws that are sized between ⅜″ to 2″. Generally, the removal of the fastener employs an impact wrench tool. Alternatively, other tools that provide needed torque may also be used. Generally, the fasteners and illustrative embodiments described herein are applicable to fasteners having right band threads. It shall be appreciated by those of ordinary skill in the art having the benefit of this description, that the fasteners and embodiments described herein may also be applied to left hand threads.

For purposes of this patent, the terms “fastener” and “screw” will be used interchangeably. Additionally for the purposes of this patent, the terms “fastener” and “bolt” will be used interchangeably, and “fastener” and “stud” will be used interchangeably. Fasteners are generally cylindrical and have a threaded end which mates with complementary threads within a fixture or a nut. For screws and bolts, there is a head of the cylinder that has a wider diameter man the threaded end. Studs and threaded rods do not have heads; studs may have a threaded top portion and a threaded bottom portion with a middle section that does not have threads.

In the embodiments presented herein, an illustrative canted coil spring is used to engage a cartridge and sleeve assembly with a camshaft and camshaft base that receives a counterclockwise or clockwise force. For purposes of this patent, the terms “sleeve and cartridge assembly” are used interchangeably with the term “combined cartridge,” which refers to cartridge being fixedly coupled to the sleeve as described in further detail below. The “jaws” of the cartridge interface with the walls of the cylindrical aperture bored or drilled into the illustrative broken fastener.

Additionally, the canted coil spring is presented as an illustrative spring technology that allows the cartridge to rotate freely, while ensuring that the cartridge does not slide out of the camshaft base. Alternatively, a knitted spring tube may also be used instead of the canted coil spring. The canted coil spring and the knitted spring tube may also be referred to as a seal preload device. Other spring technologies may also be used that allow the cartridge (which engages the socket of the screw) and the camshaft (which interfaces with the cartridge) to rotate freely in either a counterclockwise or clockwise direction, while at the same time ensuring that the camshaft base and camshaft do not slide out of the sleeve and cartridge assembly.

Additionally, the illustrative embodiment presented herein includes a three-lobed cam extending from the top surface of the camshaft, as described in further detail below. The three-lobed cam is configured to interface with the sleeve and cartridge assembly, which interfaces with the fastener. Each lobe of the illustrative three-lobed cam occupies a 120° arc and has a lobe centerline, a counterclockwise cam inner surface on one side of the lobe centerline, and a clockwise cam inner surface on the opposite side of the lobe centerline.

Generally, a counterclockwise force (to loosen the fastener) is applied to the polygonal shaped orifice in the camshaft base. This counterclockwise force is transferred from the camshaft to the cartridge when the cartridge interfaces with the lobes of the camshaft. There may be instances when fastener removal requires the application of a clockwise force and then reverting back to the counterclockwise force.

The three-lobed cam described below is provided for illustrative purposes only. Alternatively, other lobed cam assemblies may also be used such as two-lobed cam, a four-lobed cam, five-lobed cam, etc. The number of lobes and configuration of each lobe will depend on the particular fastener.

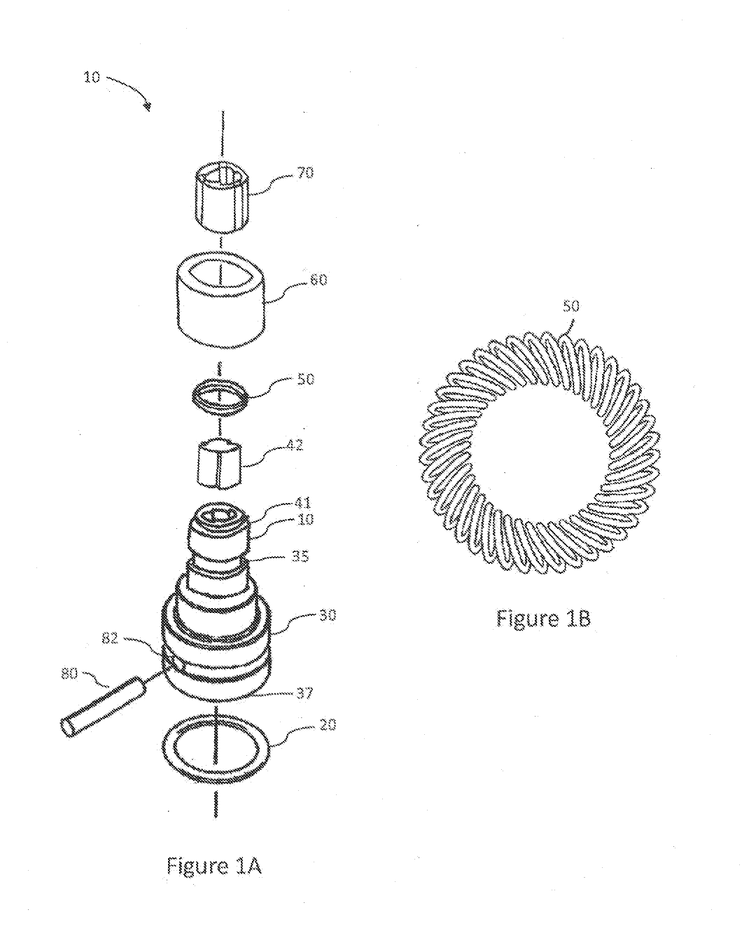

Referring to FIG. 1A there is shown an illustrative dutchman fastener removal tool 10. The dutchman fastener removal tool includes a “base;” which will also be referred to as a camshaft base 30. The dutchman fastener removal tool also includes a camshaft 42, a canted coil spring 50 and a cartridge 70. The cartridge 70 is enclosed within a sleeve 60. The camshaft base 30 may be composed of a material having the appropriate tool steel grade or stainless steel grade. The camshaft base 30 may be manufactured by machining, utilizing a mold, or other such manufacturing techniques that are specific to tool manufacturing. The camshaft base 30 includes a bottom surface 37 and a top surface 41. The camshaft bottom surface 37 may interface with a rotary tool such as an impact wrench.

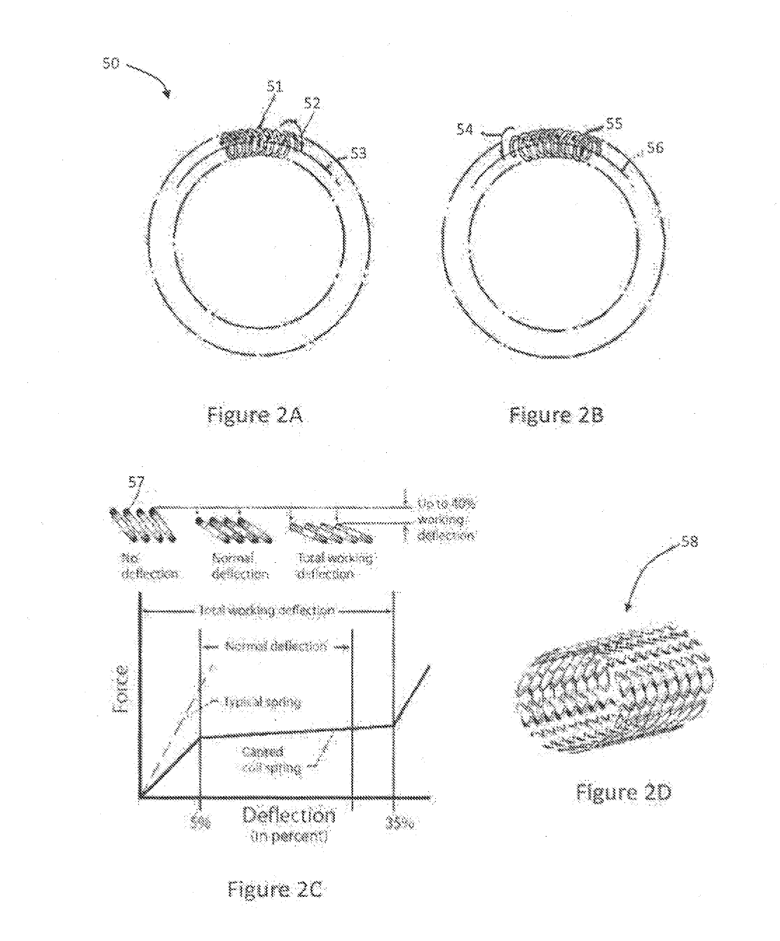

A canted coil spring 50 rests within a groove 35 between the bottom surface 37 and the top surface 41 of the camshaft base 30. FIG. 1B presents an exploded view of the canted coil spring 50. More generally, the canted coil spring 50 may be referred to as a seal preload device. For example, another illustrative seal preload device is a knitted spring tube, as shown in FIG. 2D. The canted coil spring 50 engages the sleeve 60 to the camshaft base 30, while enabling the sleeve 60 to “float” on the camshaft base 30.

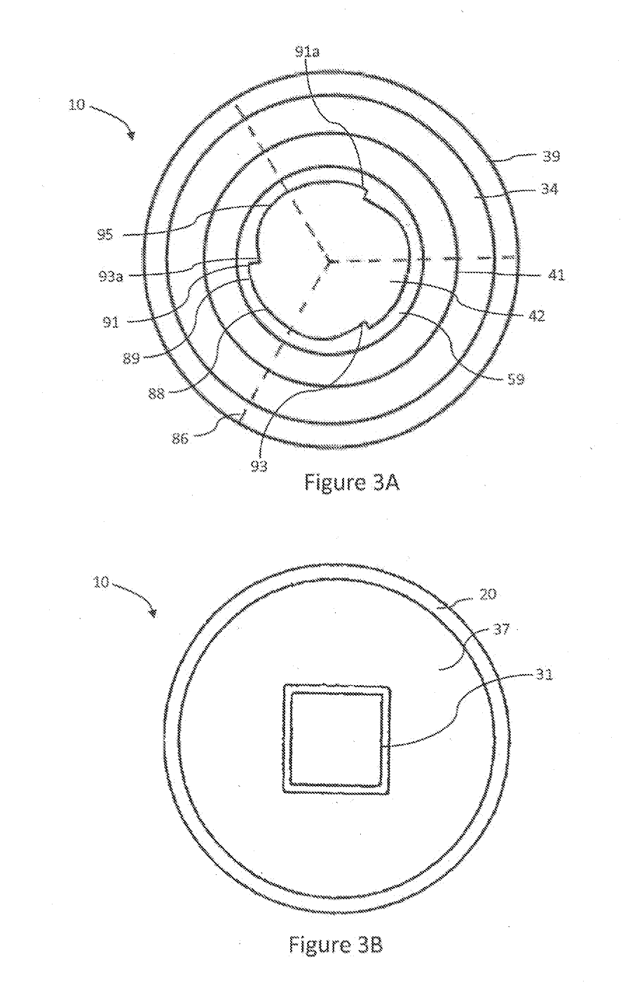

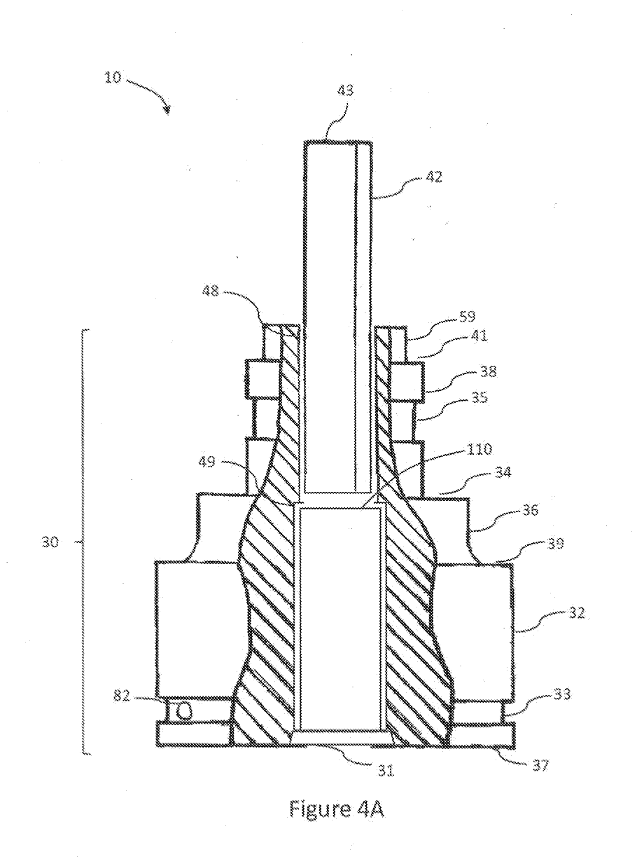

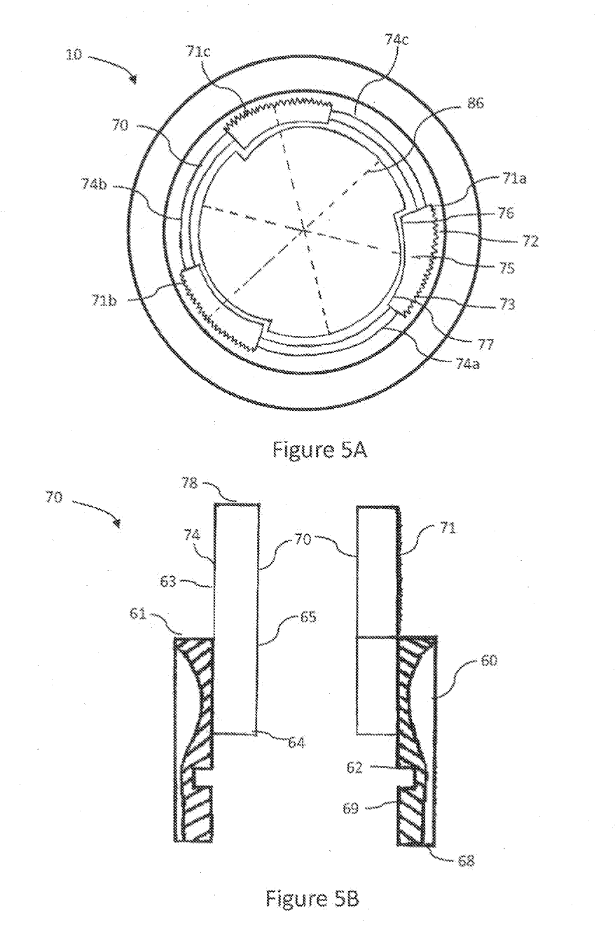

As shown in FIG. 1A, the canted coil spring 50 and the base 30 are configured to be received by the sleeve 60. The base 30 and the camshaft 42 are shown in further detail in FIGS. 3, 4A and 6 presented hereinafter. The sleeve 60 and cartridge 70 are described in further detail at FIGS. 5A, 5B & 6 hereinafter. The illustrative bottom surface 37 of the camshaft base 30 receives an illustrative O-ring 20, which is configured to interface with an illustrative impact wrench (not shown). Alternatively, the O-ring 20 may be replaced with a second canted coil spring. Further detail regarding the bottom surface 37 of the camshaft base 30 is presented in FIG. 3B, which shows a bottom view of the camshaft base bottom surface 37.

In the illustrative embodiment, the camshaft base bottom surface 37 is configured to receive an impact rotary tool. The camshaft base 30 may further include a slot 82 configured to receive a pin 80 that is inserted within the slot 82 when the camshaft base 30 is configured to interface with a rotary tool. The pin 80 holds the rotary tool in place.

Before the fastener removal tool is used, a dutchman or cylindrical aperture is drilled into the broken fastener. For example, for an illustrative broken stud in a fixture, a circular hole is drilled into the broken stud. The fastener removal tool 10 includes a fastening component with a biasing element that is configured to allow the sleeve 60 and cartridge 70 and the camshaft base 30 and camshaft 42 to rotate freely in a counterclockwise or clockwise direction, and also enable the camshaft base 30 to stay within the sleeve 60 during fastener removal and tightening operations. The illustrative fastening component with the biasing element presented herein includes seal preload device, such as a canted coil spring 50.

The illustrative embodiment may include one of two types of canted coil springs, as shown in FIGS. 2A and 2B. The first type of canted coil spring 51 presented in FIG. 2A has the coils wound in a clockwise direction about the coil centerline 53, as indicated by arrow 52. The second type of canted coil spring 55 is shown in FIG. 2B and has the cods wound in a counterclockwise direction about the coil centerline 56, as indicated by arrow 54. The illustrative canted coil spring 50 may have the coils canted in either a clockwise or counterclockwise direction depending on the particular application and design constraints.

Referring now to FIG. 2C there is shown side view of a canted coil spring 50 subject to deflection from an axial load. An axial canted coil spring has its compression force 57 parallel or axial to the centerline of the arc or ring. The graph of force vs. deflection shows the canted coil spring 50 being subjected to a range of compressive (axial) forces. As more forces 57 is applied to the canted coil spring 50, the angle between the coils and the vertical axis increases. In the “normal deflection” range shown in FIG. 2C, the normal deflection indicates that the force produced by a canted coil spring 50 is nearly constant over a long range of deflection, especially when compared to a typical spring. This enables the sleeve 60 to “float” on the canted coil spring 50.

As described in further detail below, the canted coil spring 50 is installed within grooves in both the camshaft base 30 and the sleeve 60. The canted coil spring design may be designed according to the following illustrative parameters, namely, the wire material, the wire diameter, the cant amplitude, the coils per inch, the size controlled by spring width, and eccentricity. The cant amplitude is the axial distance the top coil is shifted compared to a helical spring. The eccentricity is a parameter that indicates a circular cross section; as the eccentricity increases the spring becomes more elliptical. Some manufacturers use other parameters to design a canted coil spring such as the front angle and the back angle instead of coils per inch and cant amplitude.

When a canted coil spring is deformed, the top of the coils slide against the contact surface and the bottom coils rotate about their axis. For example, the bottom of the spring is constrained axially so the coefficient of friction is greater at the contact point between the spring and the bottom surface than the spring and the top surface; tins process enables the cage to “float” on the canted coil spring.

Another illustrative seal preload device is a knitted spring tube shown in FIG. 2D. The knitted spring tube 58 includes a series of needles interwoven about a base helix. The needle pattern is defined by the combination of a circular section and a linear section, in which both sections are piecewise continuous and smooth at their intersection.

Other parameters to consider for designing canted coil springs and knitted spring tubes are provided in the thesis entitled “MODELING OF CANTED COIL SPRINGS AND KNITTED SPRING TUBES AS HIGH TEMPERATURE SEAL PRELOAD DEVICES,” by Jay J. Oswald submitted in May 2005.

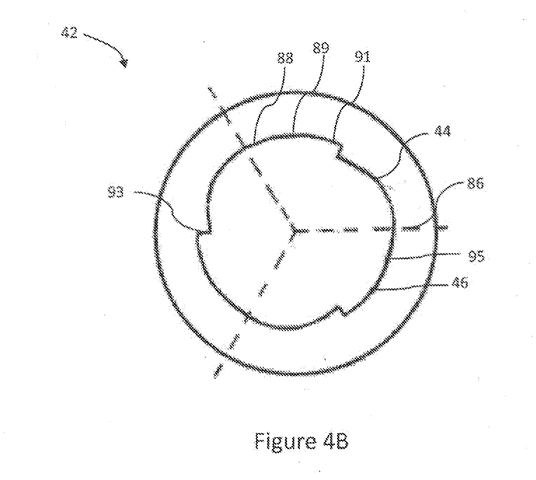

Now referring to FIG. 3A, there are three lobes 88. Each lobe 88 (also see FIG. 4B) of the camshaft 42 includes a ridge 39 that extends from the camshaft top surface to the camshaft bottom surface. Each ridge 89 is defined on one end by an elevated portion 91 and a bottom or recessed portion 93. The camshaft includes a smooth curved surface 95 between illustrative bottom portion 93a on one end and illustrative elevated portion 91a on the opposite end. The elevated portion of each ridge interfaces with the cylindrical aperture.

In the illustrative embodiment presented herein there are three lobes and each lobe has one ridge. Additionally, the ridges that are presented are linear ridges that are vertical, when the camshaft is positioned vertically (as shown in FIG. 4A). Alternatively, the ridges may have a helical shape, in which the helix angle depends on the material properties of the fastener, the material properties of the camshaft, the size of the fastener, and other such parameters that will suggest themselves to those of ordinary skill in the art having the benefit of this disclosure.

The camshaft base 30 includes a camshaft base lip 59 which receives the camshaft 42. The camshaft top surface 41 is adjacent to the camshaft lip 59. The camshaft base 30 further includes a first shoulder 34 and a second shoulder 39.

By way of example and not of limitation, the camshaft 42 is sized proportionally to the work it will perform, and the diameter may be ¼″, ⅜″, ½″, ¾″, 1″, 1½″, 2½″, 3½″, etc.

Referring now to FIG. 3B, there is shown an illustrative bottom view of the bottom surface 37. A rotary power tool is configured to slidably couple with the polygon shaped opening 31. Alternatively, a second canted coil spring may be used instead of the O-ring 20. The second canted coil spring can also absorb additional axial loading, thus enabling the cage to effectively grip the stud with minimal interference from the compressive forces emanating from the rotary power tool.

The illustrative rotary power tool may be an impact wrench (not shown) having an anvil (not shown) configured to be received by a polygon shaped opening 31 at the bottom surface 37 of the hex socket fastener removal tool 10. Although the opening is shown as being square shaped, a circular or elliptical shaped opening may also be configured to match the shape of the rotary power tool.

An impact wrench is a power tool that delivers a high torque output by storing energy in a rotating mass and then delivering the energy to the output shaft. The power source for an impact wrench is generally compressed air. When a hammer, i.e. rotating mass, is accelerated by the power source and then connected to an anvil, i.e. output shaft, it creates the high-torque impact. When the hammer spins, the hammer's momentum is used to store kinetic energy that is then delivered to the anvil in a theoretically elastic collision having a very short impact force.

With an impact wrench, the only reaction force applied to the body of the tool is the motor accelerating the hammer, and thus the operator feels very little torque, even though a very high peak torque is delivered to the anvil. The impact wrench delivers rotational forces that can be switched between counterclockwise rotation and clockwise rotation. Additionally, the impact wrenches deliver oscillating compressive forces along the axis of the anvil of the impact wrench. Thus, when removing a nut, the anvil of the impact wrench is typically along a vertical axis and the impact wrench delivers oscillating compressive forces along the axis of the anvil, i.e. axial load, and rotational forces.

Referring now to FIG. 4A, there is shown an illustrative a top view of the camshaft base 30 and the camshaft 42 having a three-lobed cam. The camshaft base includes a top surface 41, a top section 38, a first shoulder 34, a second shoulder 39, a bottom section 32 and a groove 35 that the canted coil spring 50 interfaces with. An interior sidewall 48 extends from the lip 59 to a camshaft interface 49. By way of example and not of limitation, the cam interior sidewall 48 includes three cam interior sidewall lobes. The cam interior sidewall lobes are equidistant from each other so that the arc occupied by each lobe is each approximately 120°. The cam interior sidewall 48 is configured to interface with the cam shaft 42, which interfaces with the cartridge 70 (shown on FIG. 1).

The camshaft base 30 includes a top section 38 between the camshaft top surface 41 and the first shoulder 34. The top section 38 includes a lip 59. The top section also includes the first camshaft groove 35 that is configured to receive the canted coil spring 50. The first camshaft groove 35 extends around the exterior perimeter of the camshaft base 30. The camshaft base 30 also includes a middle section 36 disposed between the first shoulder 34 and a second shoulder 39.

The camshaft base 30 further includes a bottom section 32 which extends from the second shoulder 39 to the bottom surface 37. The camshaft bottom end 32 may also include a slot 82 for receiving the pin 80 (not shown). The camshaft bottom section 32 further includes a polygon-shaped shaped opening 31 in the bottom surface 37 for interfacing with the impact wrench. The polygon shaped opening 31 extends from the bottom surface 37 to the camshaft interface 49. Additionally, a second camshaft groove 33 receives illustrative O-ring 20 (shown in FIG. 1).

The camshaft 42 interfaces with the anvil 110. When the anvil 110 is rotated counterclockwise, the camshaft 42 rotates in a counterclockwise direction. When the anvil 110 is rotated clockwise, the camshaft 42 rotates in a clockwise direction.

Referring now to FIG. 4B, there is shown the camshaft 42. The camshaft 42 includes three lobes 88. Each lobe has a lobe centerline 86. Each lobe 88 has a ridge 89 disposed between the lobe center lines. The ridge 89 includes an elevated portion 91 on one end and a bottom portion 93 on the other end. The camshaft includes a smooth curved surface 95 between the bottom portion of one ridge and the elevated portion of the next ridge. The elevated portion of each ridge interfaces with the cylindrical aperture. Additionally, each camshaft includes three counterclockwise cam surfaces 44 on the right side of each lobe centerline 86, and three clockwise cam surfaces 46 on the opposite side of the lobe centerline 86. The illustrative lobe centerlines 86 are 120° apart from each other. Each counterclockwise cam interface 44 occupies a 60° arc. Each clockwise cam interface 46 occupies a 60° arc.

Referring back to FIG. 4A, the camshaft 42 includes a top surface 43 and a bottom surface 47. In the illustrative embodiment presented herein there are three lobes 88 and each lobe has a corresponding ridge 89 (not shown). Additionally, the ridges that are presented are linear ridges that are vertical, when the camshaft is positioned vertically. As shown in FIG. 4B, the camshaft 42 further includes three counterclockwise cam surfaces 44 and three clockwise cam surfaces 46. The counterclockwise cam surfaces 44 and clockwise earn surfaces 46 both extend from the top surface 43 to the bottom surface 47.

By way of example and not of limitation, the camshaft 42 is constructed of heat treated S7 steel that measures 52-54 on the Rockwell C scale, as measured with a Hardness Tester, such as that described in U.S. Pat. No. 1,294,171, “HARDNESS TESTER,” Hugh M. Rockwell and Stanley P. Rockwell, issued Feb. 11, 1919. S7 steel is a shock-resistant, air-hardening steel used for tools which is designed for high impact resistance at relatively high hardness to withstand chipping and breaking. Other alloys may also be used. Steels used are not plated or coated, other than surface treatment to produce a black oxide finish for corrosion resistance.

By way of example and not of limitation, the camshaft base 30 is constructed of a steel having less hardness than the S7 steel used in the camshaft. The inventor hypothesizes that that the materials and shape of the tool affect the transfer of “harmonic energy” or vibrational energy from the rotary impact tool to the camshaft base and from the camshaft base to the camshaft.

Generally, a counterclockwise force is applied to the camshaft base 30 for fastener removal. This counterclockwise force is transferred to the camshaft 42, which transfers force to the sleeve and cartridge assembly described in further detail in FIGS. 5A and 5B. The sleeve and cartridge assembly interfaces with the counterclockwise cam surface 44. There may be instances when fastener removal requires the application of a clockwise force (tightening the fastener), so the camshaft base 30 is named in a clockwise direction and this force is then transferred to the camshaft 42, the cartridge 70 assembly, and the clockwise cam surface 46. An illustrative impact wrench may be employed that has an operator controlled switch that can switch the direction of the force applied to the fastener removal tool from counterclockwise, to clockwise, and back to counterclockwise. By performing this operation of oscillating between the counterclockwise and clockwise directions, additional torque may be transferred to the nut to more effectively remove the fastener.

The illustrative three-lobed cam 42 is symmetrical and is presented for illustrative purposes only. Alternatively, other symmetrical lobed cam assemblies may also be used such as a two-lobed cam, a four-lobed cam, five-lobed cam, etc. The number of lobes, size of lobes, and configuration of each lobe will depend on the particular application.

Additionally, each lobe may have more than just two symmetrical cam surfaces (i.e. clockwise inner cam surface and counterclockwise inner cam surface). For example, each lobe may have three, four, five or six different cam inner surfaces that can interface with different cages or cartridges.

Furthermore, asymmetrical cam inner surfaces may also be employed. Thus, the lobed cam inner surface may have additional surfaces beyond just the symmetrical three-lobed cam. surface presented herein. The inner cam surface may be asymmetrical and include a plurality of surfaces that can interface with a plurality of different cartridges.

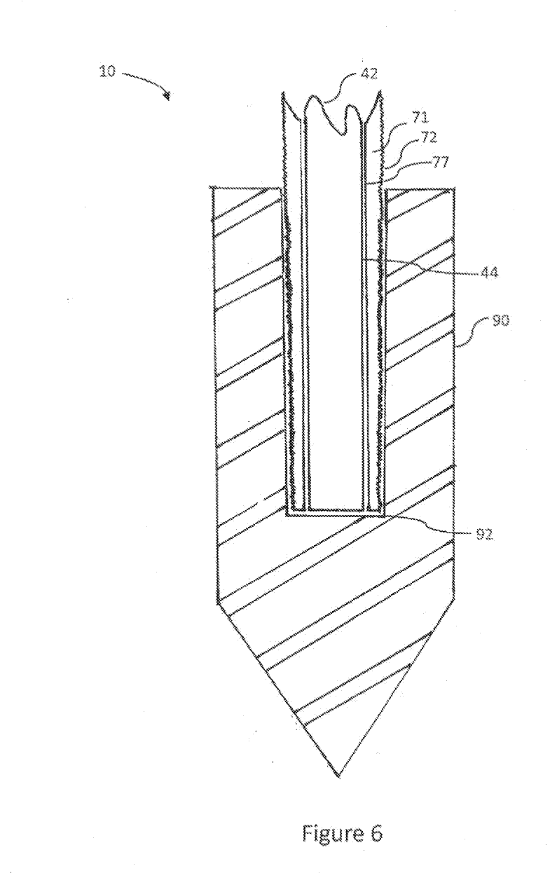

Referring now to FIG. 5A, there is shown a top view of the camshaft 42 disposed within the illustrative cartridge 70 that is interfacing the illustrative broken stud shown in FIG. 6. The cartridge includes a plurality of jaws 71. Each of the jaws 71 includes a jaw centerline 75. Each jaw centerline 75 is 120° from the other jaw centerlines. The jaw 71 may include a distal portion along the jaw centerline 75 that is furthest from the center of the cartridge 70. In other embodiment, the jaws may be substantially circular to increase the surface area that is interfacing with the wall of the cylindrical aperture.

Each of the jaws 71 includes a jaw outer counterclockwise frictional surface 73 on one side of the jaw centerline 75, and a jaw outer clockwise frictional outer surface 72 on the opposite side of the jaw centerline 75. Each jaw also includes a jaw inner counterclockwise cam surface 77 on one side of the jaw centerline 75, and a jaw inner clockwise cam surface 76 on the opposite side of the jaw centerline 75. Each jaw 71 abuts a portion of the elastic component 74, which separates the jaws and holds the jaws in place within the cartridge. The jaw outer frictional surfaces 72 and 73 may be composed a plurality of relatively small ridge shaped or pyramid shaped projections, or any other such shape that can effectively grip the walls of the cylindrical aperture.

The illustrative three-jaw cam outer surfaces may include six different frictional outer surfaces, in which three jaw frictional outer surfaces are clockwise surfaces and three frictional outer surfaces are counterclockwise surfaces. Likewise, the illustrative three-jaw cam inner surfaces include six different cam inner surfaces, in which three jaw cam inner surfaces are clockwise cam surfaces and three cam inner surfaces are counterclockwise cam surfaces. In the illustrative embodiment, each jaw counterclockwise outer frictional surface 73 and jaw clockwise outer frictional surface 72 occupies a 30° arc. The jaw counterclockwise cam inner surface 77 is configured to interface with the counterclockwise cam surface 44. The jaw clockwise cam inner surface 76 is configured to interface with the clockwise cam interface 46.

For the purposes of this patent, the terms “elastic component” and “webbing” are used interchangeably. The illustrative cartridge 70 also includes the illustrative elastic component 74a that joins and holds equally apart jaws 71a and 71b. Also, elastic component 74b joins and holds equally apart jaws 71b and 71c. Additionally, webbing 74c joins and holds equally apart jaws 71a and 71c. The webbing may also be embodied as an injection molded elastomeric cartridge or cage.

By way of example and not of limitation, the elastomeric component configured to join the jaws has a durometer ranging from 20-40. In a narrower embodiment, the elastomeric material has a durometer of 30.

Generally, the webbing material is composed of an elastic material that can withstand operating conditions for fastener removal. For example, the webbing matter may be composed of an elastic thermoplastic resin that is resistant to petroleum products. Also, other elastic or elastomeric materials such as rubber or neoprene may also be used. By way of example and not of limitation, the injection molded elastomeric cartridge or cage is composed of 1500 psi injection molded rubber.

For simplicity, the jaws 71 are shown in a resting position and are not interfacing the walls of the cylindrical aperture corresponding to the fastener. Additionally, there is no force is applied to the camshaft 42. In this testing position, the jaws 71 typically interface with the walls of hole drilled into the fastener 90, and the elastic webbing 74 used to join the jaws 71 causes the jaws 71 to remain in the resting position. In this resting position the dutchman fastener removal tool 10 is capable of accepting the fastener before a rotational force is applied to the fastener 90. The camshaft 42 includes three counterclockwise lobe surfaces 44. Additionally, the camshaft 42 includes three clockwise lobe interfaces 46. Each jaw 71 has three counterclockwise jaw frictional outer surfaces 73, and three clockwise jaw frictional surfaces 72. Further each jaw 71 has three counterclockwise cam inner surfaces 77, and each jaw 71 has three clockwise cam inner surfaces 76.

Referring now to FIG. 5B, there is shown a side view of the illustrative sleeve 60 and cartridge 70 assembly. The cartridge 70 is configured to interface with the camshaft 42. The sleeve 60 is configured to interface with the canted coil spring 50 and the camshaft base 30.

The sleeve 60 includes a sleeve lip 61, a sleeve interior sidewall 69 and a sleeve bottom surface 68. The sleeve lip 61 extends around the perimeter of the sleeve 60. The sleeve interior sidewall 69 defines an orifice in the sleeve 60 which extends from the sleeve lip 61 to the sleeve bottom surface 68. Additionally, the sleeve 60 has a sleeve groove 62 that is disposed between the sleeve lip 61 and the sleeve bottom surface 68. The sleeve groove 62 is configured to interface with the canted coil spring 50.

The cartridge 70 includes a top surface 78, three jaws 71, an elastic component 74 and an elastic lip 64. The elastic component 74 includes an exterior sidewall 63 and an interior sidewall 65. The exterior sidewall 63 of the elastic component 74 extends from the top surface 78 to the sleeve lip 61. The interior sidewall 65 of the elastic component 74 extends from the top surface 78 to the elastic lip 64.

The elastic component 74 is fixedly coupled to the jaws 71, the sleeve lip 61, and the sleeve interior sidewall 69. By way of example and not of limitation, the elastic component 74 is bonded to the sleeve interior sidewall 69, sleeve lip 61 and the jaws 71 using illustrative 30 durometer urethane rubber or other bonding material which is capable of withstanding the operating conditions of fastener removal. Additionally, the elastic component must be able to flex independently of the jaws and sleeve in a lateral direction.

Referring cow to FIG. 1A, FIG. 4A and FIG. 4B, when inserted into the sleeve 60, the camshaft base 30 slidably engages with the sleeve interior sidewall 69, and the camshaft 42 slidably engages with the cartridge jaws 71 and the interior sidewall 65 of the elastic component 74. Further, the top section 38 of the camshaft base 30 slides past the canted coil spring 50 fitted within the sleeve groove 62, and the canted coil spring 50 is received by the first camshaft groove 35. The top surface 41 of the camshaft base 30 interfaces with the elastic lip 64 of the sleeve 60. The sleeve bottom surface 68 interfaces with the first shoulder 34 of the camshaft base 30. When the canted coil spring 50 is secured within both the sleeve groove 62 and the first camshaft groove 35, the camshaft base 30 latches within the sleeve 60 with the canted coil spring 50, holding the camshaft base 30 in place within the sleeve 60.

Referring now to FIG. 6, there is shown a cross-sectional view of the camshaft 42 and cartridge disposed within the illustrative broken stud 90. A dutchman 92 is drilled into the top of the broken stud 90. The diameter of the dutchman 92 is drilled sufficiently wide to prevent breakage of the camshaft 42 within the stud 90. By way of example and not of limitation, the dutchman is drilled to a depth that is 1.5 times the diameter of the stud 90.

When counterclockwise force is applied to the camshaft base 30, it causes the camshaft 42 to shift to the left and the jaws 71 are biased radially outwards by the camshaft 42. When the camshaft 42 is rotated counterclockwise by a rotary power source, such as the air impact wrench described above, this counterclockwise force causes the counterclockwise lobe interface 44 to engage with the counterclockwise jaw cam inner surface 77. When the jaws are biased radially outwards by the camshaft 42, and the effective circumference of the cartridge is enlarged, this causes the elastic webbing 74 to flex (not shown). When the jaws 71 are biased radially outwards, the jaw counterclockwise outer frictional surfaces 73 engage the dutchman 92 drilled into the fastener 90.

More specifically, the dutchman fastener removal tool is configured to turn in a counterclockwise manner. This rotation causes the camshaft counterclockwise cam surfaces to apply force to the jaw counterclockwise cam inner surfaces 77. In operation, the deformation of the elastic component 74 upon the application of torque allows for the jaw counterclockwise outer frictional surface 73 to contact the dutchman 92 drilled into the fastener 90 at multiple contact points. At the same time, the rubber cartridge maintains symmetry between the three jaws and keeps the jaws pressed firmly against the surfaces of the cam ramps. As the jaws move up the cam increasing the diameter of the cartridge, the rubber flexes outwardly allowing for maximum retention and providing stability for the jaws.

There may be instances when fastener removal requires the application of a clockwise force (tightening the fastener) so the camshaft base 30 is turned in a clockwise direction. When this clockwise force is applied to the camshaft base 30, it causes the camshaft to shift to the right and the jaws are biased radially outwards by the cam. As shown in FIG. 5A, when the camshaft 42 is rotated clockwise by a rotary power source, snob as the air impact wrench described above, this clockwise force causes the clockwise lobe interface 46 to engage with the clockwise jaw cam inner surface 76. When the jaws 71 are biased radially outwards by the camshaft 42, and the effective circumference of the cartridge is enlarged, this causes the elastic webbing 74 to flex (not shown). When the jaws 71 are biased radially outwards, the jaw clockwise outer frictional surface 72a, 72b, and 72c engages the dutchman drilled into the fastener 90.

Generally, the dutchman fastener removal tool is used in a counterclockwise manner. In some circumstances the fastener removal tool may also be configured to turn in a clockwise manner, and this rotation causes the camshaft clockwise cam surfaces, 46a, 46b and 46c to apply force to the jaw clockwise cam inner surfaces 76a, 76b and 76c, respectively. In operation, the deformation of the elastic component 74 upon the application of torque allows for the jaw clockwise outer frictional surface 72a, 72b, and 72c, respectively, to contact the dutchman 92 at multiple contact points.

Additionally, during fastener removal, the operator may increase the amount torque applied to the fastener by toggling between applying a counterclockwise force and a clockwise force using the dutchman fastener removal assembly described herein.

The illustrative cartridge 70 having three jaws 71 is symmetrical and is presented for illustrative purposes only. Alternatively, other symmetrical jaw inner cam assemblies may also be used such as an assembly having two jaws, four jaws, five jaws, etc. The number of jaws and configuration of each jaw will depend on the particular application.

Additionally, each jaw may have more than one symmetrical cam surface in which the earn surfaces mirror one another. Thus, the clockwise outer frictional surface and counterclockwise outer frictional surface may share the same outer diameter.

Furthermore, asymmetrical jaw outer frictional surfaces may also be employed. Thus, the jaw outer frictional surface may have additional surfaces beyond just the symmetrical three-jaw cam surface presented herein. The jaw outer frictional surface may be asymmetrical and include a plurality of surfaced that can interface with a plurality of different fastener shapes.

It is to be understood that the detailed description of illustrative embodiments provided for illustrative purposes. The scope of the claims is not limited to these specific embodiments or examples. Various structural limitations, elements, details, and uses can differ from those just described, or be expanded on or implemented using technologies not yet commercially viable, and yet still be within the inventive concepts of the present disclosure. The scope of the invention is determined by the following claims and their legal equivalents.

What is claimed is:

1. An apparatus for removing a fastener having a cylindrical aperture, the apparatus comprising:
a base that includes,
a base top section having a base top surface;
a base bottom section having an opening at a base bottom surface for interfacing with a rotary tool;
a camshaft extending from the base top surface that includes a camshaft top surface and at least one lobe that extends from the camshaft top surface to the base top surface and has a camshaft cam profile;
the camshaft configured to be rotatable in unison with the base;
a sleeve that includes a sleeve lip, a sleeve bottom surface and a sleeve inferior sidewall disposed between the sleeve lip and the sleeve bottom surface;
a cartridge that includes a cartridge top surface, a cartridge lip and a plurality of jaws, in which each jaw includes a jaw counterclockwise outer frictional surface and a jaw counterclockwise inner cam surface;
the cartridge configured to be fixedly coupled to the sleeve;
the cartridge configured to interface with the camshaft;
the at least one jaw inner cam surface configured to interface with the camshaft cam profile of the at least one lobe; and
the jaws of the cartridge configured to rotate and engage the walls of the cylindrical aperture of the fastener.

2. The apparatus of claim 1 wherein the lobe includes at least one ridge that extends front the camshaft top surface to the base top surface.

3. The apparatus of claim 1 further comprising an elastic component configured to join the plurality of jaws and the sleeve.

4. The apparatus of claim 1 wherein the lobe includes a linear ridge extending from the camshaft top surface to the base top surface, wherein the camshaft includes a smooth curved surface that leads to the ridge that further includes an elevated portion and a recessed portion.

5. The apparatus of claim 4 wherein the jaw counterclockwise inner cam surface is configured to engage with the camshaft cam profile when a counterclockwise force is applied to the camshaft.

6. The apparatus of claim 1 wherein the camshaft lobe includes at least three ridges that are configured to interface with the cartridge, in which the jaws of the cartridge interface with the walls of the cylindrical aperture.

7. The apparatus of claim 1 wherein the opening in the base bottom section further comprises a slot configured to receive a pin that is inserted within the slot when the base bottom section interfaces with the rotary tool.

8. The apparatus of claim 1 further comprising an elastic component configured to join the plurality of jaws and the sleeve, wherein the elastic component has a cylindrical portion that inserts into the sleeve and is bonded to the interior sidewall of the sleeve.

9. An apparatus for removing a fastener having a cylindrical aperture, the apparatus comprising:
a base that includes,
a base top section having a base top surface and a base groove;
a base bottom section having an opening at a base bottom surface for interfacing with a rotary tool;
a camshaft extending from the base top section that includes a camshaft top surface and a plurality of lobes that each extends from the camshaft top surface to the base top surface, wherein each lobe includes a ridge that extends from the camshaft top surface to the base top surface;
the camshaft configured to be rotatable with the base;
a sleeve that includes a sleeve lip, a sleeve bottom surface and a sleeve interior sidewall disposed between the sleeve lip and the sleeve bottom surface, wherein the sleeve interior sidewall includes a sleeve groove;
a cartridge that includes a cartridge top surface, a cartridge lip and a plurality of jaws, in which each jaw includes a jaw counterclockwise outer frictional surface and a jaw counterclockwise inner cam surface;
the cartridge configured to be fixedly coupled to the sleeve;
a canted coil spring configured to be received by the sleeve groove and the base groove, wherein the canted coil spring enables the cartridge to interface with the camshaft;
the inner cam surface of each of the jaws configured to interface with one of the lobes of the camshaft; and
the jaws of the cartridge configured to rotate and engage the walls of the cylindrical aperture of the fastener.

10. The apparatus of claim 9 further comprising an elastic component configured to join the plurality of jaws and the sleeve.

11. The apparatus of claim 9 wherein the counterclockwise inner cam surface of each of the jaws is configured to engage with a camshaft counterclockwise cam surface when a counterclockwise force is applied to the camshaft.

12. The apparatus of claim 9 wherein the opening in the base further comprises a slot configured to receive a pin that is inserted within the slot when the opening in the base interfaces with the rotary tool.

13. The apparatus of claim 9 further comprising an elastic component configured to join the plurality of jaws and the sleeve, wherein the elastic component comprises a cylindrical member having a bottom portion that inserts into the sleeve and is bonded to the interior sidewall of the sleeve and a top portion extending from the sleeve, the top portion having a plurality of slots, each containing one of the jaws.

14. An apparatus for removing a fastener having a cylindrical aperture, the apparatus comprising:
a base that includes,
a base top section that extends from a base top surface to a shoulder, the base top having a base top surface and a base groove disposed between the base top surface and the shoulder;
a base bottom section that extends from the shoulder to a bottom surface, the bottom section including an opening in the bottom surface for interfacing with a rotary tool;
a camshaft extending from the base top surface for rotation with the base, the camshaft including a camshaft top surface and a plurality of lobes, each of the lobes including a ridge extending from the camshaft top surface to the base top surface, wherein each of the ridges further includes an elevated portion and a recessed portion, and each lobe includes a curved surface from the recessed portion of one of the ridges to the elevated portion of another of the ridges;
a sleeve that includes a sleeve lip, a sleeve bottom surface and a sleeve interior sidewall disposed between the sleeve lip and the sleeve bottom surface, the sleeve interior sidewall including a sleeve groove;
a cartridge that includes a cartridge top surface, a cartridge lip and a plurality of jaws, each of the jaws including a jaw counterclockwise outer frictional surface and a jaw counterclockwise inner cam surface;
a canted coil spring configured to be received by the sleeve groove and the groove of the base,
the cartridge configured to be fixedly coupled to the sleeve;
the base configured to rotate relative to the sleeve;
the cartridge configured to rotate and engage the fastener; and
the canted coil spring configured to operate within a constant deflection range when an axial load is applied.

15. The apparatus of claim 14 further comprising an elastic component configured to join the plurality jaws and the sleeve.

16. The apparatus of claim 14 wherein the counterclockwise inner cam surface of each of the jaws is configured to engage with a camshaft counterclockwise cam surface of each of the curved surfaces of the camshaft when a counterclockwise force is applied to the camshaft.

17. The apparatus of claim 14 wherein the camshaft includes at least three of the ridges.

18. The apparatus of claim 14 wherein the base further comprises a slot configured to receive a pin that is inserted within the slot and through the opening in the bottom surface of the base when the opening interfaces with the rotary tool.

19. The apparatus of claim 14 further comprising an elastic component configured to join the plurality of jaws and the sleeve, wherein the elastic component has a cylindrical portion that inserts into the sleeve and is bonded to the interior sidewall of the sleeve.

20. The apparatus of claims 14 further comprising an elastic component configured to join the plurality of jaws and the sleeve, wherein the elastic component comprises a cylindrical member having a bottom portion that inserts into the sleeve and is bonded to the interior sidewall of the sleeve and a top portion extending from the sleeve, the top portion having a plurality of slots, each containing one of the jaws.
